(19) United States
(12) Patent Application Publication
(10) Pub. No.: US 2018/0012253 A1
(43) Pub. Date: Jan. 11, 2018

(54) CONTENT DATA MODEL FOR OPTIMIZED CONTENT CREATION

(71) Applicant: Facebook, Inc., Menlo Park, CA (US)

(72) Inventors: Avi Samuel Gavlovski, Kirkland, WA (US); Aditya Pradip Kulkarni, Sunnyvale, CA (US); Xiaotao Chen, Bellevue, WA (US); Benjamin Tucker Savage, London (GB)

(21) Appl. No.: 15/499,803

(22) Filed: Apr. 27, 2017

Related U.S. Application Data
(60) Provisional application No. 62/359,645, filed on Jul. 7, 2016.

(51) Int. Cl. G06Q 30/02

(52) U.S. Cl. CPC G06Q 30/0251; G06Q 30/0276

(57) ABSTRACT

An online system provides a content data model to content providers for optimizing content creation. The content data model is a hierarchical model with multiple levels for content creation, e.g., campaign level, content item set level and content item level. At each level of the content data model, a content provider can specify certain information concerning the content creation at that level, such as optimization goal for each level. The information specified at each level of the content data model is applied to all elements under that level by the online system during the content creation process. With the content data model, a content provider can efficiently design creative campaigns by specifying objectives, optimization goals, target audiences and budgets, etc., at different design levels. The online system dynamically optimizes content item creation based on information about creatives to be included in a content item for a target user.

### CROSS-REFERENCE TO RELATED APPLICATIONS

This application claims the benefit of Provisional Patent Application No. 62/359,645, filed on Jul. 7, 2016, which is hereby incorporated by reference in its entirety.

### BACKGROUND

### 1. Field of Art

This disclosure generally relates to online content creation, and particularly to providing a content data model to optimize online content creation.

### 2. Description of the Related Art

Content providers create content that is targeted to certain audiences within an online system, where users of the online system interact with the content received from the online system, e.g., clicking, sharing, watching a video, subscribing to a service, or purchasing a product described by the content. With the advent of online systems such as social networking systems, content providers have increasingly relied on the online systems to create effective sponsored content within the online system to greatly increase engagement among users of the online systems. For example, an online system tracks how often users interact with the presented content and collects statistics for the content such as conversion rate. These statistics may be accrued over numerous content campaigns with different content items and serve to measure the effectiveness of each content item in the campaign in view of targeting audiences and budget. Based on these statistics, the content provider can revise content items that perform poorly or alternatively choose to show content items that have performed very effectively.

Online systems can provide data models or tools to help content providers create content to be delivered to users of the online system. However, existing solutions of online systems offer content providers very limited flexibility in creating content, which results in a very complicated content creation process. For example, a content provider has a campaign on promoting brand name running shoes, and the campaign has a first subset of promotions targeting men within a certain age range for a specified amount of budget and a second subset of promotions targeting women within a certain geographical location for a different amount of budget. Within each subset of promotions, the content provider wants to create different content items targeting the same target audiences, e.g., the running shoes of same style but in different colors for men between ages 18 to 30. Although different content items under the same subset share the same target audiences, objectives, and budget, every time the content provider wants to add a new content item, current solutions require the content provider to repeat all the information already shared by the other content items within the same subset (e.g., target audiences, objectives, budget, etc.,) plus the new information (e.g., the new color). Requiring content providers to define information associated with content creation separately for each content item leads to a complicated and less optimized content creation process for content providers.

### SUMMARY

An online system provides a content data model to content providers for optimizing content creation. With the content data model, the online system makes it easier for a content provider to design content campaigns by simplifying the design process by which the content provider can specify objectives, optimization goals, target audiences and budgets, etc., at different design levels.

In one embodiment, the content data model is a hierarchical model with multiple levels for content creation, e.g., three hierarchical levels: campaign level, content item set level and content item level. Each campaign can have one or more content item sets; each content item set includes one or more content items; and each content item has one or more creatives (e.g., images, text, URLs, titles, etc.) At each level of the content data model, a content provider can specify certain information concerning the content creation at that level, such as optimization goal for each level.

The information specified at each level of the content data model by the content provider is applied to all elements under that level by the online system during the content creation process. For example, at the content item set level, a content provider provides all of the information at that level to be applied across all content items in the set (e.g., bid, budget, billing event, optimization goals, etc.); at the content item level, the content provider just provides the creative themselves to be included in the content item without repeating the information needed at a level above, e.g., the content item set level. Thus, the same information defined at the content set level can be conveniently applied across all content items rather than requiring the complexity and extra work of the content provider having to specify it separately for every content item. In addition, the online system then can determine how best to apply this information across the different content items (e.g., how to split the budget across different content items), rather than requiring the content provider to make this determination.

The online system dynamically optimizes content item creation and serving of content items based on the information at the data model levels and based on information about creatives to be included in a content item for a target user. For example, the online system receives a number of creatives from a content provider, and assembles the creatives into a sponsored content item for a target user. The online system can also receive, from the content provider, information describing how the sponsored content item is created, such as the optimization goal, target audience and total budget shared by the content item to be created and other content items within the same content item set. For each opportunity to present a sponsored content item to a user (or a target audience that includes the user), the online system selects an optimal creative for each type of creative. For example, the optimal image is selected from multiple image candidates. The online system assembles the selected creatives into a sponsored content, which represents the optimal assembly of creatives for the user (or for the audience that includes the user). In some embodiments, the content provider provides assembled content items. In this case, the online system selects assembled content items for display to users based on the targeting criteria specified at the content item set level for all content items in the set, and divides the budget across those content items based on the budget specified at the content item set level.

### BRIEF DESCRIPTION OF DRAWINGS

FIG. 1 is a block diagram of a system environment for content creation with a content data model according to one embodiment.

FIG. 2 is a block diagram of an online system for content creation with a content data model according to one embodiment.

FIG. 3A is a block diagram of a content data model with five design levels for content creation according to one embodiment.

FIG. 3B shows an example a content data model with three design levels for content creation according to one embodiment.

FIG. 4 shows a content creation user interface for a content provider to specify information for different design levels with a content data model according to one embodiment.

FIG. 5 shows an example a content item created with a content data model according to one embodiment.

FIG. 6 is a flowchart illustrating a process for content creation with a content data model according to one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. System Overview

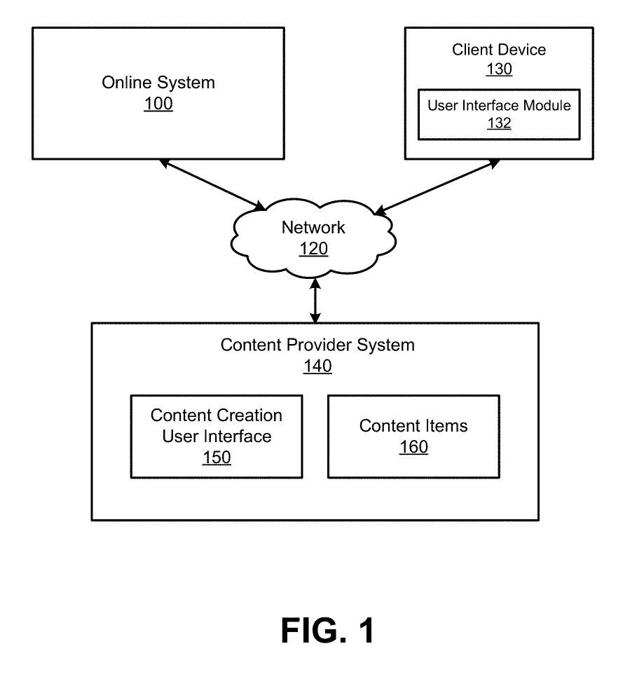

FIG. 1 is a block diagram of a system environment for content creation with a content data model according to one embodiment. The system environment includes an online system 100, a client device 130, and a content provider system 140 connected to each other over a network 120. In other embodiments, different and/or additional entities can be included in the system environment. The online system 100 provides a content data model to the content provider system 140 such that content providers can use the content data model to efficiently create content items. The online system 100 also allows users of the online system 100 to communicate or otherwise interact with each other and access content items provided by the online system 100 and/or the content provider system 140 through users' client devices 130. In one embodiment, the online system 100 is a social networking system.

The client device 130 is a computing device capable of receiving user input as well as transmitting and/or receiving data via the network 120. In one embodiment, a client device 130 is a conventional computer system, such as a desktop or laptop computer. Alternatively, a client device 130 may be a device having computer functionality, such as a personal digital assistant (PDA), a mobile telephone, a smartphone or another suitable device. A client device 130 is configured to communicate via the network 120. In one embodiment, a client device 130 executes an application allowing a user of the client device 130 to interact with the online system 100. For example, a client device 130 executes a browser application to enable interaction between the client device 130 and the online system 100 via the network 120. In another embodiment, a client device 130 interacts with the online system 100 through an application programming interface (API) running on a native operating system of the client device 130, such as IOS® or ANDROID™.

In one embodiment, the client device 130 has a user interface module 132 that a user can provide input to the online system 100 and the content provider system 140. For example, the user may retrieve content for viewing and indicate an affinity towards the content by posting comments about the content or recommending the content to other users. Alternatively a user may indicate a dislike towards the content by flagging the content or closing or hiding the content window, thereby indicating that the user is not interested in the content.

The network 120 includes any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 180 may be encrypted using any suitable technique or techniques.

The content provider system 140 is used by content providers for interacting with the online system 100. Examples of interactions include providing content, components of the content (also referred to as “component creatives” or simply “creatives”), and information related to the content and the creatives to the online system 100. The content providers use a content data model provided by the online system 100 to define information associated with content creation, e.g., target audiences, optimization goals, budget, billing event, bid amount, at various design levels, e.g., campaign level, content items set level and content items level. An optimization goal is a metric that the online system 100 aims to maximize, e.g., maximize purchases, maximize clicks, etc. A billing event is an event that a content provider (e.g., an advertiser) gets charged in association with a content item provided by the content provider or created for the content providers, e.g., when a user sees the content item, clicks the content item, or installs an application linked to by the content item. A bid amount is a monetary value that a content provider places on an event associated with an optimization goal set by the content provider. In the embodiment shown in FIG. 1, the content provider system 140 has a content creation user interface 150 and content items 160. The content provider system 140 interacts with the online system 100 using application programming interfaces (APIs) of the online system 100.

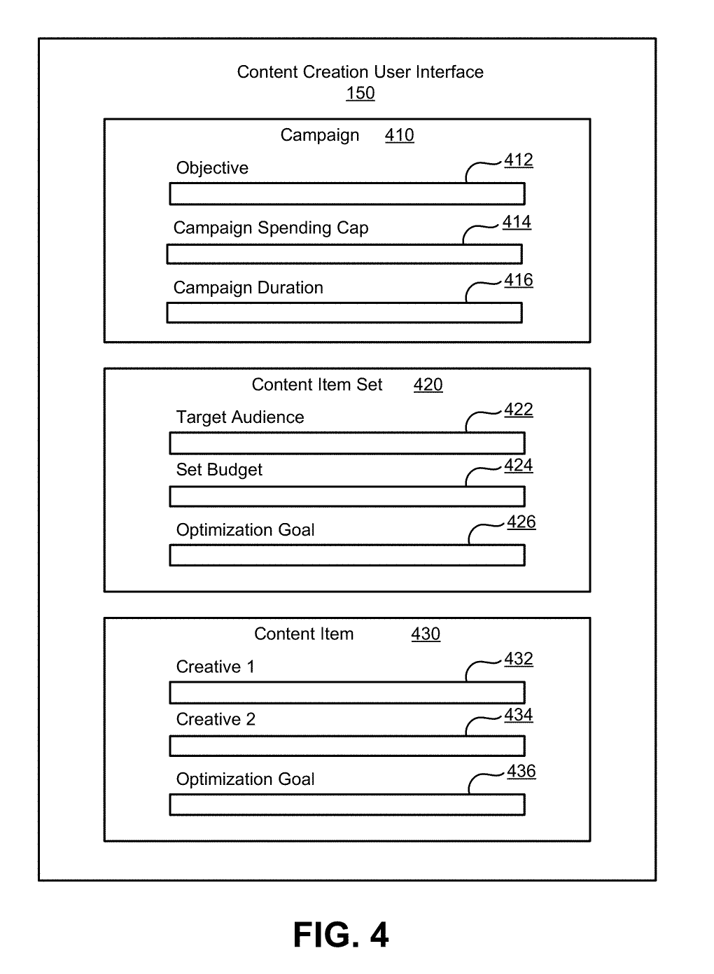

The content creation interface module 150 receives instructions from the online system 100 to generate a user interface (e.g., an example shown in FIG. 4), includes input forms (e.g., a text box, drop down menu, radio buttons, file upload button, etc.) for a content creator to provide information concerning the content creation at different levels to the online system 100. Each level of information is associated with a corresponding hierarchical level of the content data model provided by the online system 100. An example of the content user interface module 150 is further illustrated below with reference to FIG. 4.

A content creator also uses the content provider system 140 to provide one or more content items 160 and/or creatives to be included in a content item 160 to the online system 100. A content item may be sponsored content such as advertisements sponsored by advertisers. A content item 160 is a combination of a number of creatives; each creative is a part of the content item 160 to be presented to a target user and each creative is of a type. Examples of types of creatives includes image, video, body representing the primary message of the content item, call_to_action_type (e.g., shop_now, learn_more, etc.,), title representing a short headline in the content item, description representing secondary message of the content item, universal resource locator (URL), and caption representing corresponding text of an URL. In one embodiment, a content provider provides a content item 160 having a set of predetermined creatives to the online system 100 for presentation to a target user, e.g., {Image A, Title A, Body B}. In another embodiment, a content provider provides a set of creatives to the online system 100, which dynamically decides which creative to use in the content item 160 to be delivered to a target user. For example, a content provider is able to provide a content item 160 in a set having the following different types of creatives:

```
{
  Images: {ImageA, ImageB, ImageC}
  Titles: {TitleA, TitleB, TitleC }
  Body: {BodyA, BodyB, BodyC}
}
```

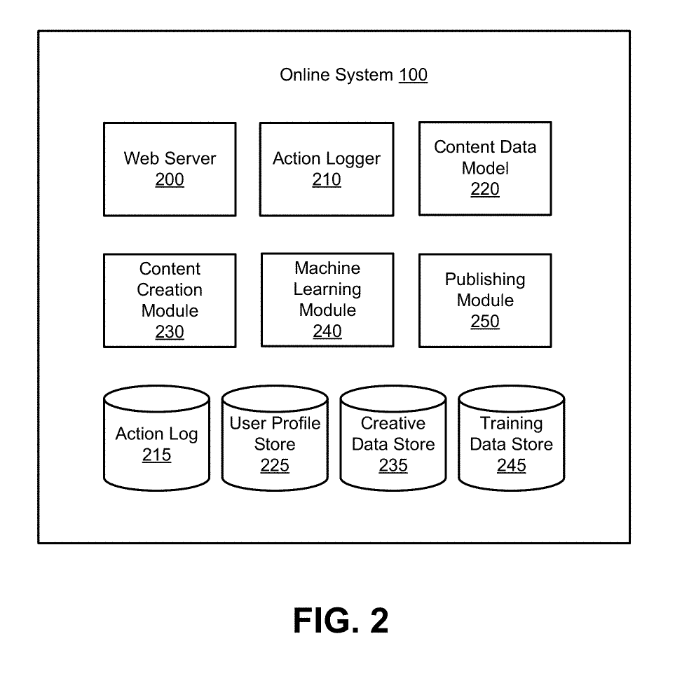

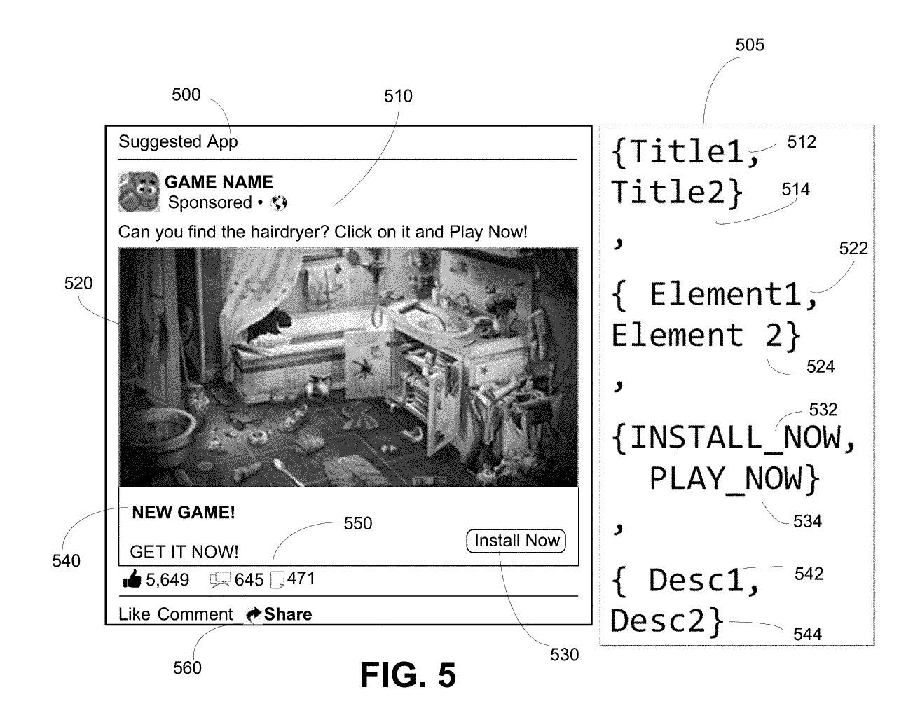

The online system 100 receives the creatives and information associated with the content creation, e.g., target audiences, optimization goals and budget, from the content provider system 140 and dynamically creates a content item using one or more of the creatives in accordance with the associated content creation information. The content creation is further described below with reference to FIG. 2 and FIG. 5.

### II. Online System

FIG. 2 is a block diagram of the online system 100 for content creation with a content data model according to one embodiment. The online system 100 includes a web server 200, action logger 210, content data model 220, content creation module 230, machine learning module 240, publishing module 250, action log 215, user profile store 225, creative data store 235, and training data store 245. In other embodiments, the online system 100 may include additional, fewer, or different modules for various applications such as an edge store and a newsfeed manager.

The web server 200 links the online system 100 via the network 120 to the one or more client devices 130 as shown in FIG. 1. The web server 200 serves web pages, as well as other web-related content, such as web-content written in JAVA®, FLASH®, XML and so forth. The web server 200 may receive and route messages between the online system 100 and the client device 130, for example, instant messages, queued messages (e.g., email), text messages, short message service (SMS) messages, or messages sent using any other suitable messaging technique. A user may send a request to the web server 200 to upload information (e.g., images or videos) that are stored in the user profile store 225. Additionally, the web server 200 may provide application programming interface (API) functionality to send data directly to native client device operating systems, such as IOS®, ANDROID™, WEBOS® or RIM®.

The action logger 210 receives communications about user actions internal to and/or external to the online system 100, populating the action log 215 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 215.

The action log 215 may be used by the online system 100 to track user actions on the online system 100, as well as actions on third party systems that communicate information to the online system 100. Users may interact with various objects on the online system 100, and the action logger 210 stores information describing these interactions in the action log 215. Examples of interactions with objects include: commenting on posts, sharing links, and checking-in to physical locations via a mobile device, accessing content items, and any other interactions. Additional examples of interactions with objects on the online system 100 that are included in the action log 215 include: commenting on a photo album, communicating with a user, establishing a connection with an object, joining an event to a calendar, joining a group, creating an event, authorizing an application, using an application, expressing a preference for an object (“liking” the object), and engaging in a transaction.

Additionally, the action log 215 may record a user's interactions with sponsored content on the online system 100 as well as with other applications operating on the online system 100. In some embodiments, data from the action log 215 is used to infer interests or preferences of a user, augmenting the interests included in the user's user profile and allowing a more complete understanding of user preferences. The action log 215 can record information about client devices 130 that a user uses to interact with the online system 100. For example, the action log 215 records whether the user used a laptop computer or smartphone client device to interact with the online system 100. Further, the action log 215 may include information about the types of client devices 130, e.g., smartphone running an IOS® or ANDROID™ operating system.

The action log 215 may also store user actions taken on a content provider system 140, such as an external website, and communicated to the online system 100. For example, the external website may recognize a user of an online system 100 through a social plug-in enabling the external website to identify the user of the online system 100. Since users of the online system 100 are uniquely identifiable, external websites may communicate information about a user's actions outside of the online system 100 to the online system 100 for association with the user. Hence, the action log 215 can record information about actions that users perform on a content provider system 140 including webpage viewing histories, sponsored content that were engaged, purchases made, and other patterns from shopping and buying.

The user profile store 225 stores user profiles associated with each user of the online system 100. A user profile includes declarative information about the user that was explicitly shared by the user and may also include profile information inferred by the online system 100. In one embodiment, a user profile includes multiple data fields, each describing one or more attributes of the corresponding user of the online system 100. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 100 displayed in an image. A user profile in the user profile store 225 may also maintain references to actions by the corresponding user performed on the online system 100. The user profile store 225 further stores data describing one or more relationships between different users and allows users to specify their relationships with other users. For example, these user-defined relationships allow users to generate relationships with other users that parallel the user's real-life relationships, such as friends, co-workers, partners, and the like.

The user profile store 225 can store user profiles associated with individuals, as well as user profiles associated with entities such as businesses or organizations, e.g., that own a content provider system 140. This allows an entity to establish a presence on the online system 100 for connecting and exchanging content with other users of the online system 100. The entity may post information about itself, about its products, or provide other information to users of the online system 100 using a brand page associated with the entity's user profile. Users of the online system 100 may connect to the brand page to receive information posted to the brand page or to receive information from the brand page. A user profile associated with the brand page may include information about the entity itself, providing users with background or informational data about the entity.

An edge store (not shown in FIG. 2) stores information describing connections between users and other objects on the online system 100 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 100, such as expressing interest in a page on the online system 100, sharing a link with other users of the online system 100, and commenting on posts made by other users of the online system 100. Users and objects within the online system 100 can be represented as nodes in a social graph that are connected by edges stored in the edge store.

In one embodiment, the online system 100 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. The newsfeed manager (not shown in FIG. 2) may generate stories for presentation to a user based on information in the action log 215 and in edge store or may select candidate stories included in a content store. One or more of the candidate stories are selected and presented to a user by the newsfeed manager.

The machine learning module 240 trains one or more content creation models using features based on training data from the training data store 245. In one embodiment, the machine learning module 240 trains the content creation models using one or more machine learning algorithms such as neural networks, naïve Bayes, and support vector machines with the training data stored in the training data store 245. The machine learning module 240 can store the content creation models in the online system 100 and periodically re-train the content creation models using features based on updated training data. Example features include demographics of target users, a geographic region of target users, a creative (e.g., an image, video, or text), objectives, optimization goals, or budget. In some embodiments, the training data store 245 includes predetermined information about a population of users of the online system 100 provided to the online system 100 or from another module of the online system 100, e.g., the action log 215 or user profile store 225. Examples of the training data include statistics of past advertisement campaigns, such as the click-through rate (CTR) or impression rate, of previously presented creatives or content items of assembled creatives. The training data store 245 also stores training data describing user information of various types of target audiences, e.g., age, gender, demographic group, socioeconomic status.

The content creation module 230 uses the content creation models trained by the machine learning module 240 to create content items from the creatives stored in the creative data store 235 for display to a target user. The creative data store 235 stores creatives, e.g., photos, videos, bodies of text, etc., provided by a content provider system 140 to the online system 100, e.g., via the content creation user interface 150. In some embodiments, the creative data store 245 stores creatives received by the online system 100 from other sources such as users of the online system 100 or a database of a creatives accessible on an online server, e.g., a database of photos of tourist travel destinations or a database of descriptions of a company's product. The creative data store 235 can store content items created by the content creation module 230, which can be retrieved by the publishing module 250 for publishing at a later time. The content creation module 230 is further described below with reference to FIG. 5. In some embodiments, the creatives are assembled by the content provider, in which case the creative data store 235 stores assembled content items.

The publishing module 250 selects content items to be published for display to users of the online system 100 in detection of a user logging into the online system 100. Each content item has a content value for representing the compensation (e.g., monetary value) received by the online system 100 if the candidate content item is presented to the target user and/or if the target user interacts with the candidate content item. Different pricing models may be used to determine the content value, such as a cost-per-click (i.e., “CPC”) model where the content value is based on a per-user-interaction with the candidate content item, or a cost-per-impression (i.e., “CPI”) model where the content value is based on the number of times a candidate content item is presented. The online system 100 receives more compensation by publishing content items including sponsored content associated with high content values. Thus, in a typical scenario, the publishing module 330 selects a first content item for publishing over a second content item if the content value of the first content item is greater than the content value of the second content item.

### III. Content Data Model

The content data model 220 is a hierarchical model with multiple levels for content creation by content providers. In one embodiment, the content data model 220 has at least three hierarchical levels: campaign level, content item set level and content item level. Each campaign can have one or more content item sets; each content item set includes one or more content items; and each content item has one or more creatives (e.g., images, text, URLs, titles, etc.) For example, a content provider wants to create a campaign for NIKE® running shoes, which includes a few content item sets, e.g., NIKE® Pro 6 running shoes set and NIKE® Ultimate running shoes set. Within each content item set, the content provider can have a number of different content items. For example, within NIKE® Pro 6 running shoes set, the content provider can have a content item including an image of NIKE® Pro 6 running shoes and corresponding text for men and another content item including an image of NIKE® Pro 6 running shoes for women and a different corresponding text.

At each level of the content data model 220, a content provider can specify certain information concerning the content creation at that level, such as optimization goals for each level. Examples of optimization goals for various hierarchical levels of the content data model 220 include numbers of applications installed, clicks, impressions, lick clicks, media downloads, offsite conversions, page likes, post engagement, and video views.

The information specified at each level of the content data model 220 by the content provider is applied to all elements under that level by the online system 100 during the content creation process. For example, at the content item set level, a content provider provides all of the information at that level to be applied across all content items in the set (e.g., bid, budget, billing event, optimization goals, etc.); at the content item level, the content provider just provides the creative themselves to be included in the content item without repeating the information needed at a level above, e.g., the content item set level. Using the NIKE® running shoes above as an example, a content provider using the content data model 220 specifies a campaign level objective: e.g., number of impression, reach, applications installed, or conversion rate on content items for NIKE® Pro 6 running shoes campaign. The campaign level objective is applied to all the content item sets, e.g., NIKE® Pro 6 running shoes set and NIKE® Ultimate running shoes set.

For another example, given a content item set level budget provided by a content provider, instead of the content provider trying to figure out how he wants to divide up his budget across different content items in the content item set under existing solutions, the content provider now just specifies the budget for the content item set, and the online system 100 applies the specified content item set level budget to various content items under that set. For example, the online system 100 may apply 80% of the budget to just one content item because that is the most successful one in terms of conversion rate, which was specified by the content provider as the optimization goal for the content item set level. The online system 100 learns from the training data, and applies the budget more effectively than the content provider could, which also saves the content provider time and complexity of trying to determine the optimal budget distribution.

The content data model 220 also enables a content provider to set an optimization goal to optimize content creation on a billing event, e.g., conversions of a content item (instead of clicks or likes on the content item), but to be billed on a different billing event (e.g., impressions). With the content data model 220, a content provider can experiment with different options for optimization goals versus billing events and selects the best combination that helps achieves the optimization goals set by the content provider.

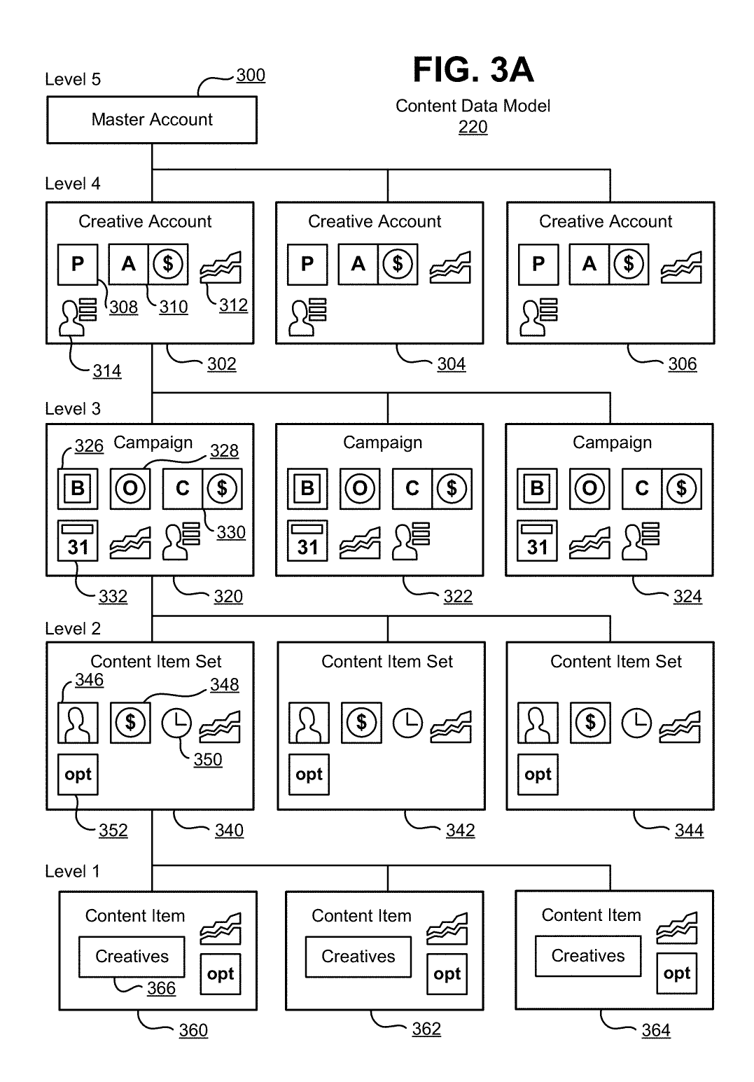

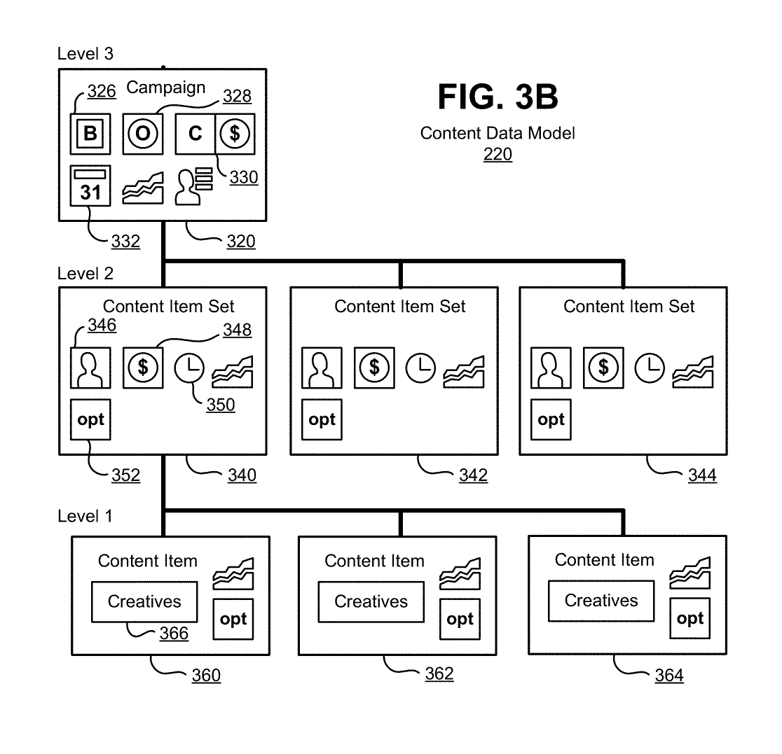

FIG. 3A is a block diagram of a content data model 220 for content creation according to one embodiment. In the embodiment illustrated in FIG. 3A, the content data model 220 is a hierarchical model with five levels. Level 5 represents a master account 300, which may be associated with a content provider system 140. The master account 300 may be associated with one or more master creators who want to create and publish content items on the online system 100. The master creators may be, for example, owners or managers of a business. The master account 300 is associated with one or more creative accounts represented by level 4 of the content data model 220, for example, creative accounts 302, 304, and 306. Each creative account can be associated with one or more other users (e.g., content item creators or content providers) of the online system 100. In some embodiments, a creative account is also associated with a master creator. A master creator can use the master account 300 to manage the associated creative accounts. For example, the master account 300 sets parameters of the associated creative accounts 302, 304, and 306, which is further described below.

A creative account is associated with one or more parameters. In particular, the creative account 302 is associated with one or more properties 308, an account spending cap 310, a reporting 312, and/or a set of rules and permissions 314. A property 308 represents an entity that can be described by one or more linked business objects, for example, a company brand, website, webpage, event, application, gift, product, and the like. The account spending cap 310 indicates a maximum budget (e.g., in United States Dollars) that the corresponding creative account can spend on publishing a number of content item sets on the online system 100, each of which has one or more content items. The maximum budget may be based on a duration of time (e.g., $1000 per month) or indicate a total budget available until completely used or expired after an expiration date. A reporting 312 describes metrics associated with published content items of the corresponding creative account. For example, the metrics indicate a budget spent on published content items over a period of time, aggregate demographic information of users of the online system 100 who interact with the published content items, or a total number of views or clicks of the published content items. A set of rules and permissions 314 describes rules and permissions that the corresponding creative account must follow. For example, a rule indicates that a creative account can only publish one content item per day, a content item designed by a creative account must be approved by the corresponding master account before publishing, or the creative account can only publish content items to a certain target audience (e.g., based on demographic information).

A creative account may be associated with one or more campaigns represented at level 3 of the content data model 220. In particular, creative account 302 is associated with campaigns 320, 322, and 324. As described above, a campaign is a collection of content item sets, i.e., associated with one or more content item sets represented by level 2 of the content data model 220. A campaign is associated with one or more parameters. In particular, the campaign 320 is associated with a business object 326, an objective 328, a campaign spending cap 330, a campaign duration 332, a reporting, and a set of rules and permissions. The reporting and a set of rules and permissions are substantially the same as the reporting 312 and a set of rules and permissions 314, but are applied at the campaign level (i.e., level 3) instead of the creative account level (i.e., level 4). The objective 328 indicates a purpose of the corresponding campaign. For example, the objective 328 of the campaign 320 is to promote a science fair a high school. The campaign spending cap 330 indicates a maximum budget that the corresponding campaign can spend on publishing content items on the online system 100. The campaign duration 332 indicates a period of time during which the corresponding campaign will publish content items.

A campaign may be associated with one or more content item sets represented at level 2 of the content data model 220. In particular, campaign 320 is associated with content item sets 340, 342, and 344. A content item set is associated with one or more parameters. In particular, the content item set 340 is associated with an audience 346, budget 348, set schedule 350, reporting, and an optimization goal 352. The audience 346 indicates a target audience of users of the online system 100 for content items of the corresponding content item set. The budget 348 indicates a maximum budget that the corresponding content item set can spend on publishing content items associated with the content item set on the online system 100. The set schedule 350 indicates times at which content items of the corresponding content item set are scheduled to be published. For example, the times indicate a time of day (e.g., mornings or 8-LOAM), a day of the week (e.g., Fridays or Saturdays), or a time pattern (e.g., the first Monday of each month). The optimization goal 352 indicates one or more optimizations that are used to increase the likelihood that a target user of the online system 100 will interact with a given content item of the corresponding creative set.

A content item set is a collection of content items, i.e., associated with one or more content items represented by level 1 of the content data model 220. In particular, content item set 340 is associated with content items 360, 362, and 364. A content item includes one or more creatives and is associated with one or more parameters. In particular, the content item 360 includes creatives 366 (e.g., an image of a product and a body of text describing the product) and is associated with a reporting and an optimization goal, which are substantially the same as the reporting 312 and the optimization goal 352, but are applied at the content item level (i.e., level 1) instead of the creative account level (i.e., level 4) and the content item set level (i.e., level 2), respectively.

In an example use case, a creator (e.g., business owner) of the creative account 302 generates the campaign 320 to promote a science fair at a high school, the campaign 322 to promote a school fundraiser, and the campaign 324 to promote a school basketball game. Further, for the campaign 320, the creator generates the content item set 340 to organize content items targeted to parents of students attending the science fair, the content item set 342 to organize content items targeted to sponsors of the science fair, and the content item set 344 to organize content items targeted to science and math teachers. The creator provides the creative 360 including a photo of an erupting volcano science fair project, the creative 362 including a photo of a robotic racecar science fair project, and the creative 364 including a photo of a chemistry experiment science fair project. In some embodiments, the creator provides the three photos to the content data model 220 and the online system 100 dynamically selects which photo to use for a particular content item.

To help the creator to efficiently create the content items 360, 362 and 364, the content data model 220 enables the creator to set information concerning the content creation at the content item set level (e.g., level 2), which is applied to all elements below that level. Using the science fair promotion example describe above, the creator sets the optimization goal 352 of the content item set 340 is to increase the number of multimedia views by the parents attending the science fair, the online system 100 can suggest the creator to include a photo of sample projects (e.g., a robotic racecar) in the content items 360, 362 and 364 to be created because the parents are more likely to be interested in the science fair if they view photos of sample projects. Accordingly, the parents are more likely to interact with the content item (including the photo of sample projects) to learn more about the science fair.

Though the content data model 220 shown in FIG. 3A includes five levels, it should be noted that in other embodiments, the content data model 220 may include additional levels, fewer levels, and/or different types of levels. For example, FIG. 3B shows an example of the content data model 220 with three hierarchical levels: campaign (level 3), content item sets (level 2) and content items (level 1).

The online system 100 provides the content data model 220 to a content provider by providing a content creation user interface to the content provider, where the content provider is able to specify information associated with content creation at different levels. FIG. 4 shows a content creation user interface 150 for a content provider to specify information associated with content creation at three levels, which correspond to the hierarchy of the content data model 220 according to one embodiment. The content creation user interface 150 has three sets of input boxes: 410 for campaign level information, 420 for a content item set of the campaign, and 430 of a content item in the content item set. The content creation user interface 150 is created in accordance with the content data model 220 shown in FIG. 3B, which has three hierarchical levels: campaign, content item sets and content items.

At the campaign level, the content provider provides information concerning the content creation at that level. For example, the content provider can specify the objective of the campaign through input box 412, campaign spending cap via input box 414 and campaign duration via input box 416. The campaign level information controls the content item sets, e.g., content item set 420, included in the campaign. For example, no content item set within the campaign can spend more than the amount defined by the campaign spending cap.

At the content item set level, the content provider specifies information concerning the content creation at that level. For example, the content provider can specify the target audience targeted by the content items within the content item set through input box 422, the total budget for the content items within the content item set via input box 424 and optimization goal (e.g., conversation rate) via input box 416. The content item set level information controls creation of the content items within the content item set, e.g., content item 430. For example, no content item within the content item set can spend more than the amount defined by the total budget for all the content items within the content item set. However, the content provider does not need to specify individual budget for each content item within the same content item set; instead, the online system 100 dynamically allocates the total set budget among the content items within the content item set in order to achieve the optimization goal set by the content provider.

At the content item level, the content provider specifies information concerning the content creation at that level. For example, to create a content item (e.g., 430) of the content item set 420, the content provider provides information of one or more creatives, e.g., creative 1 (an image of product) through input box 432, creative 2 (a body of text describing the product) through input box 434, and optimization goal for the content item (e.g., CTR) via input box 436. In another embodiment, the content provider can provide multiple creatives of a same type via the content creation user interface 150. For example, the content provider can provide to different images of a same product for the content item 430 through the input boxes 432 and 434. The content creation module 230 of the online system 100 receives the two images of the product for the content item 430 and dynamically determines which of the two images to be included in the content item 430 to better achieve the optimization goal associated with the content item 430 specified by the content provider. Furthermore, the content provider of the creation of content item 430 does not need to repeat the information concerning the content creation, which is shared by other content items within the same content item set, because such information has been set once by the content provider at the content item set 420 level.

### IV. Content Creation

The content creation module 230 of the online system 100 generates content items from creatives provided by content providers based on information from the content data model 220 as previously described. The content creation module 230 provides the generated content items for the content provider system 140 for publishing on the online system 100 and/or the content provider system 140. In one embodiment, the content creation module 230 generates content items based on information about creatives stored in the creative data store 235. The creative data store 235 stores creatives, e.g., photos, videos, bodies of text, etc., provided by a content provider system 140 to the online system 100, e.g., via the content creation user interface 150 as described above. In some embodiments, the creative data store 235 stores creatives received by the online system 100 from other sources such as users of the online system 100 or a database of a creatives accessible on an online server, e.g., a database of photos of tourist travel destinations or a database of descriptions of a company's product.

In embodiment, the content creation module 230 dynamically optimizes content items based on information about creatives to be included in a content item for a target user of the online system 100. For example, the content creation module 230 receives a number of creatives from a user of the content provider system 140 (e.g., a content provider), and assembles the creatives into a sponsored content item. The content creation module 230 can also receive, from the content provider, information describing how the creatives should be included in the sponsored content item, such as the optimization goal, target audience and total budget allocated to the content items set containing the content item to be created. For each opportunity to present a sponsored content item to a user (or a target audience that includes the user), the content creation module 230 selects an optimal creative for each type of creative. For example, the optimal image creative is selected from multiple image creative candidates. The selection occurs based on a component model trained to dynamically optimize creatives of that type. The content creation module 230 assembles the selected creatives into a sponsored content, which represents the optimal assembly of creatives for the user (or for the audience that includes the user).

The content creation module 230 creates a content item to for each target user of the online system 100. In particular, each user of the online system is presented with a sponsored content item having a number of creatives, which are dynamically selected based on the user's information and information describing the creatives. Different users of the online system are provided with different sponsored content composed of different creatives, each creative optimally selected for that audience or that user. For example, the content creation module 230 retrieves information about a target user of the online system 100 from the user profile store 225 indicating the target user's demographics (e.g., age, gender, or ethnicity) or the target user's connections (e.g., indicating the target user's friends or family members in real life). Further, the content creation module 230 retrieves information about the target user from the action log 215 indicating the user's preferences based on actions performed by the user (e.g., certain brand pages that the target user liked or types of content items that the target user frequently interacts with). Based on the retrieved information, the content creation module 230 generates a content item that the target user is likely to interact with. In an example use case, the demographics indicate that the target user is a 25 year old male, and the target user's actions indicate that the target user is interested in basketball. Thus, the content creation module 230 generates a content item including a video about basketball, which is selected from multiple basketball videos provided by the content provider, and has been viewed by many users of the online system 100 who are males in the 20-30 year old range. Example embodiments of the content creation module 230 are further described in U.S. application Ser. No. 15/199,386, filed on Jun. 30, 2016, which is hereby incorporated by reference herein in its entirety.

FIG. 5 shows an example a content item 500 created with a content data model by the content creation module 230 according to one embodiment. A user of the content provider system 140 provides, to the online system 100, a set of creatives 505, including two titles: Title1 512 and Title2 514, two image elements, Element1 522 and Element2 524, two call_to_action_types: INSTALL_NOW 532 and PLAY_NOW 534, two descriptions: Desc1 542 and Desc2, 544. The content creation module 230 dynamically decides a creative for each type to be included in the content item 500 for a target user. For example, the content creation module 230 selects a title 510 (i.e., “Can you find the hairdryer? Click on it and Play Now!”) from two title candidates 512 and 514, an image 520 from two image candidates 522 and 524, a call_for_action_type 530 (i.e., “Install Now”) from the two call_for_action_type candidates 532 and 534, and a description 540 (i.e., “NEW GAME”) from two description candidates 542 and 544.

The content item 500 also includes engagement metrics about interactions performed by users of the online system 100 with the content item 500. For example, the metric 550 indicates how many users expressed interest in the content item 500, how many comments about the content item 500 were posted by users and how many times users shared the content item 500 on the online system 100. Further, the content item 270 includes buttons 560 for the users to engage with the content item 500, e.g., buttons to express interest, post a comment, or share the content item 500.

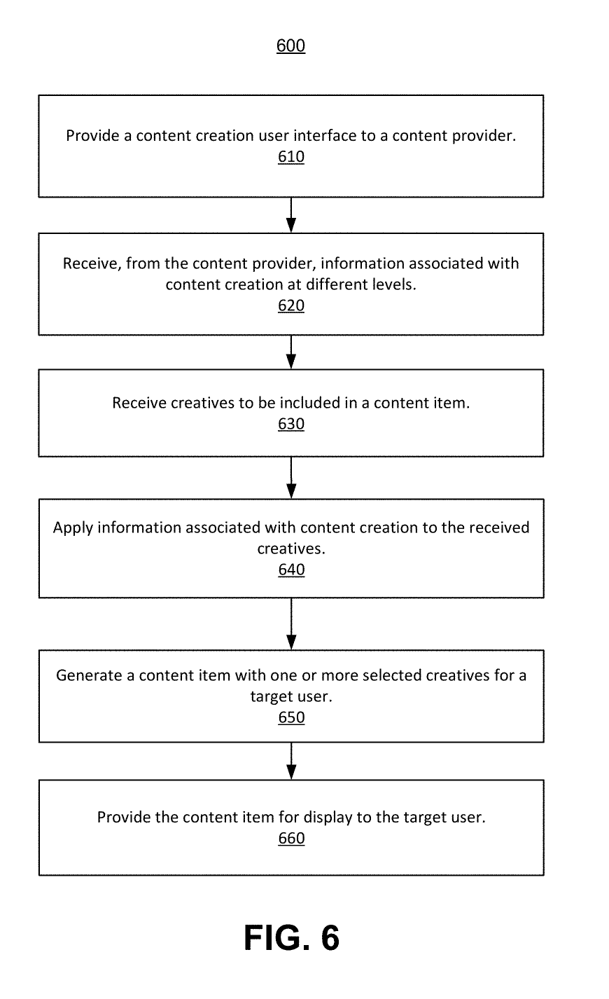

FIG. 6 is a flowchart illustrating a process 600 for content creation with a content data model according to one embodiment. In some embodiments, the process 600 is used by the online system 100, e.g., modules of the online system 100 described with reference to FIG. 2. The process 600 may include different or additional steps than those described in conjunction with FIG. 6 in some embodiments or perform steps in different orders than the order described in conjunction with FIG. 6.

The online system 100 provides 610 a content creation user interface to a content provider such as the interface 150 shown in FIG. 4. In one embodiment, the content creation user interface is created in accordance with a content data model, e.g., the content data model 220 shown in FIG. 3B, where the content data model 220 is a hierarchical model with three levels for content creation. The content provider uses the content creation user interface to provide information associated with content creation at different levels. The online system 100 receives 620 from the content provider information associated with content creation at different levels, e.g., budget, targeting audiences and optimization goals, and receives 630 one or creatives to be included in a content item or alternatively receives a plurality of content items that were already assembled by the content provider.

The online system 100 applies 640 the information regarding the creation of the content item. For example, the online system 100 determines how much of the total budget defined at the content item set level by the content provider is allocated to the content item to be created in view of the optimization goal set for the content item. The online system 100 dynamically selects a creative among multiple creatives of a same type for each type of creative to be included in the content item and generates 650 the content item with the selected creative, or if the content item was pre-assembled by the advertiser, it selects the appropriate content item for the target user based on the targeting criteria. The online system 100 provides 660 the generated content item for display to the target user.

In some embodiments, some or all of the applying 640 step occurs at impression time when there is an impression opportunity to present a content item to a user. The online system 100 determines that the user is a target user if the user falls within the targeting criteria for that content item. The targeting criteria may have been defined at the content item set level, so these same targeting criteria are applied by the system across all content items in the set. Similarly, the appropriate portion of the budget to apply may be determined at impression time. The content provider may have specified the budget at the content item set level, and the online system divides the budget across all the content items in the set. Thus, the online system 100 determines the appropriate amount to bid in an auction for presenting the content item to a target user by considering this budget and the division across the content items.

### V. General

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable non-transitory medium containing computer program code, which can be executed by a computer processor for performing any or all of the steps, operations, or processes described.

Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
providing a content creation user interface to a content provider, the content creation user interface being generated in accordance with a content data model;
receiving, from the content provider, content item set information associated with content creation, the content item set information including parameters associated with targeting users and a budget amount to create a plurality of content items associated with a content item set;
storing the content item information associated with content creation at a content item set level of the content data model;
receiving, from the content provider, content item information associated with content creation, the content item information including parameters associated with a plurality of creatives to be included in the plurality of content items for the target users associated with the content item set;
storing the content item information describing parameters associated with content creation at a content item level of the content data model;
applying the information associated with content creation stored at the content item set level across the plurality of content items in the content item set, each content item in the content item set having one or more creatives of a plurality of creatives described by the information stored at the content item level;
generating the content items associated with the content set based on application of the information associated with content creation; and
providing the content items for display to the target users.

2. The method of claim 1, wherein the content data model is a hierarchical model with a plurality of levels for defining information associated with content creation at the plurality of levels.

3. The method of claim 2, wherein the plurality of levels of the content data model include:
a campaign level for defining information of a campaign to be created, a campaign comprising one or more content item sets;
a content item set level for defining information of a content item set to be created, a content item set comprising one or more content items; and
a content item level for defining information of a content item to be created, a content item comprising one or more creatives to be included in the content item.

4. The method of claim 3, wherein the information of a campaign to be created includes at least one of:
objective of the campaign;
campaign spending cap; and
campaign duration.

5. The method of claim 3, wherein the information of a content item set to be created includes at least one of:
target audience of the content item set;
budget for the content item set; and
optimization goal of the content item set.

6. The method of claim 3, wherein the information of a content item to be created includes at least one of:
information describing each creative to be included in the content item; and
optimization goal of the content item.

7. The method of claim 2, wherein the information associated with content creation at a level of the content data model applies to each element at a next lower level in the hierarchy, and wherein:
information defined at a campaign level applies to each content item set within the campaign;
information defined at a content item set level applies to each content item within the content item set; and
information defined at a content item level applies to each creative within the content item.

8. The method of claim 1, wherein generating a content item comprising one or more creatives comprises:
applying a trained creative model to each creative based on a plurality of creative features associated with the creative and one or more user features of the target user;
generating a prediction score of each creative based on the application of the trained creative model; and
selecting a creative for each type of creative among the one or more creatives having a same type based on the prediction scores of the one or more creatives.

9. The method of claim 8, further comprising:
determining whether the selected creative is in accordance with the information associated with content creation at content item level; and
including the selected creative in the content item responsive to the selective creative being in accordance with the information associated with content creation at content item level.

10. The method of claim 1, wherein generating a content item comprising one or more creatives further comprises:
dynamically determining allocation of budget for a content item set for each content item within the content item set, wherein a content item within the content item set best meeting optimization goal of the content item set receives the largest amount of the budget for the content item set among other content items in the same content item set.

11. A computer program product comprising a non-transitory computer readable storage medium having instructions encoded thereon that, when executed by a processor, cause the processor to perform the steps including:
providing a content creation user interface to a content provider, the content creation user interface being generated in accordance with a content data model;
receiving, from the content provider, content item set information associated with content creation, the content item set information including parameters associated with targeting users and a budget amount to create a plurality of content items associated with a content item set; and
storing the content item information associated with content creation at a content item set level of the content data model;
receiving, from the content provider, content item information associated with content creation, the content item information including parameters associated with a plurality of creatives to be included in the plurality of content items for the target users associated with the content item set;
storing the content item information describing parameters associated with content creation at a content item level of the content data model;
applying the information associated with content creation stored at the content item set level across the plurality of content items in the content item set, each content item in the content item set having one or more creatives of a plurality of creatives described by the information stored at the content item level;
generating the content items associated with the content set based on application of the information associated with content creation; and
providing the content items for display to the target users.

12. The non-transitory computer readable storage medium of claim 11, wherein the content data model is a hierarchical model with a plurality of levels for defining information associated with content creation at the plurality of levels.

13. The non-transitory computer readable storage medium of claim 12, wherein the plurality of levels of the content data model include:
a campaign level for defining information of a campaign to be created, a campaign comprising one or more content item sets;
a content item set level for defining information of a content item set to be created, a content item set comprising one or more content items; and
a content item level for defining information of a content item to be created, a content item comprising one or more creatives to be included in the content item.

14. The non-transitory computer readable storage medium of claim 12, wherein the information associated with content creation at a level of the content data model applies to each element at a next lower level in the hierarchy, and wherein:
information defined at a campaign level applies to each content item set within the campaign;
information defined at a content item set level applies to each content item within the content item set; and
information defined at a content item level applies to each creative within the content item.

15. A computer-implemented method comprising:
providing a content creation user interface to a content provider, the content creation user interface being generated in accordance with a content data model;
receiving, from the content provider, content item set information associated with content creation, the content item set information including parameters associated with targeting users and a budget amount to create a plurality of content items associated with a content item set;
storing the content item information associated with content creation at a content item set level of the content data model;
receiving, from the content provider, content item information associated with content creation, the content item information including parameters associated with a plurality of creatives to be included in the plurality of content items for the target users associated with the content item set;
storing the content item information describing parameters associated with content creation at a content item level of the content data model;
receiving, from the content provider, a plurality of content items for display to the target users, the plurality of content items being associated with a content item set;
applying the information associated with content creation stored at the content item set level and stored at the content item level to the received plurality of content items;
detecting impression opportunities to display content items of the plurality of content items to target users that were defined according to the information stored at the content set level;
for each impression opportunity, providing a bid amount in auction for display of a content item of the received plurality of content item to the target users, the bid amount determined according to the information stored at the content set level; and
providing each of the received plurality of content items for display to the target users responsive to the content item winning the auction.

16. The method of claim 15, further comprising:
receiving, from the content provider, information describing at least one optimization goal associated with the content item set; and
storing the optimization goal at the content item set of the content data model.

17. The method of claim 16, further comprising:
dynamically determining allocation of budget described by the information stored at the content item set for each content item in the content item set, wherein a content item within the content item set best meeting optimization goal of the content item set receives the largest amount of the budget for the content item set among other content items in the same content item set.

18. The method of claim 16, further comprising,
dynamically determining allocation of budget described by the information stored at the content item set for each content item in the content item set according to conversion rate of each content item, wherein a content item within the content item set has the highest conversion rate in the content item set receives the largest amount of the budget for the content item set among other content items in the same content item set.

19. The method of claim 15, further comprising:
receiving, from the content provider, information describing an optimization goal associated with the content item set, the optimization goal being measured based on a billing event; and
receiving, from the content provider, billing information describing how the content provider is billed for the content items displayed for the target users, the billing information associated with a billing event different from the billing event associated with the optimization goal of the content item set.

20. The method of claim 19, wherein the billing event associated with the optimization goal is conversion rate of a content item displayed to the target user, and the billing event associated with billing information is impression of the content item.
